(19) United States
(12) Patent Application Publication
(10) Pub. No.: US 2016/0207212 A1
(43) Pub. Date: Jul. 21, 2016

(54) SYSTEM AND METHOD FOR CUTTING HASSELBACK FOOD ITEMS

(71) Applicant: McCain Foods Limited, Florenceville-Bristol (CA)

(72) Inventors: David M. Rogers, Woodstock (CA); John Warren Aikens, New Maryland (CA); Carlos Rincon, Florenceville-Bristol (CA)

(21) Appl. No.: 14/597,840

(22) Filed: Jan. 15, 2015

(51) Int. Cl. B26D 3/08; B26D 7/06; B26D 1/00; B26D 5/06

(52) U.S. Cl. CPC B26D 3/08; B26D 5/06; B26D 7/0625; B26D 1/0006; B26D 2001/006

(57) ABSTRACT

A system for cutting hasselback food items is disclosed. The system includes a conveyor having an upper surface for supporting at least one food item and for moving the food item along a path, and a cutting device positioned above the conveyor along the path. The cutting device includes an array of four or more parallel side-by-side cutting blades. A method of cutting hasselback food items is also disclosed.

### FIELD

This application relates to the field of cutting food items, such as fruit or vegetables.

### INTRODUCTION

This application relates to systems and methods for making hasselback-shaped food items. More particularly, this application relates to systems and methods for forming a plurality of substantially parallel spaced apart cuts in a portion of a food item.

### SUMMARY

In a first aspect, a system for cutting hasselback food items is provided. The system may comprise a conveyor having an upper surface for supporting at least one food item and for moving the food item along a path, and a cutting die positioned above the conveyor along the path. The cutting die may comprise an array of four or more parallel wavy cutting blades positioned side-by-side. The cutting die may be movable between a retracted position above the food item and an extended position for moving the cutting blades through an upper portion of the food item. In the extended position, the cutting blades may be spaced apart from the upper surface of the conveyor to leave a lower portion of the food item uncut.

In some embodiments, in the extended position, at least one of the cutting blades may be spaced apart from the upper surface of the conveyor by a first distance and at least one other of the cutting blades may be spaced apart from the upper surface of the conveyor by a second distance different from the first distance.

In some embodiments, the array of cutting blades may include central cutting blades positioned between peripheral cutting blades, and in the extended position, each of the central cutting blades may be spaced apart from the upper surface of the conveyor by a first distance, and each of the peripheral cutting blades may be spaced apart from the upper surface of the conveyor by a second distance greater than the first distance.

In some embodiments, the conveyor may include a plurality of spikes extending upwardly from the upper surface for impaling the food item.

In some embodiments, the cutting blades in the array may be evenly spaced apart.

In another aspect, a system for cutting hasselback food items is provided. The system may comprise a conveyor having an upper surface for supporting at least one food item and for moving the food item along a path, and a cutting device positioned above the conveyor along the path. The cutting device may include an array of four or more parallel cutting blades positioned side-by-side. The cutting device may be movable between a retracted position above the food item and an extended position for moving the cutting blades through an upper portion of the food item. In the extended position, each of the cutting blades may be spaced apart from the upper surface of the conveyor to leave a lower portion of the food item uncut, at least one of the cutting blades may be spaced apart from the upper surface of the conveyor by a first distance, and at least one other of the cutting blades may be spaced apart from the upper surface of the conveyor by a second distance different from the first distance.

In some embodiments, the conveyor may include a plurality of spikes extending upwardly from the upper surface for impaling the food item.

In some embodiments, the array of cutting blades may include central cutting blades positioned between peripheral cutting blades, and in the extended position, each of the central cutting blades may be spaced apart from the upper surface of the conveyor by a first distance, and each of the peripheral cutting blades may be spaced apart from the upper surface of the conveyor by a second distance greater than the first distance.

In some embodiments, the cutting blades in the array may be evenly spaced apart.

In another aspect, a system for cutting hasselback food items is provided, the system may comprise a conveyor having an upper surface for supporting at least one food item and for moving the food item along a path, and a powered cutting device positioned above the conveyor along the path. The cutting device may be drivingly coupled to an array of four or more parallel side-by-side cutting blades. The cutting device may drive the cutting blades in a reciprocating movement. The array of cutting blades may be movable between a retracted position above the food item and an extended position for moving the cutting blades, while reciprocating, through an upper portion of the food item. In the extended position, the cutting blades may be spaced apart from the upper surface of the conveyor to leave a lower portion of the food item uncut.

In some embodiments, in the extended position, at least one of the cutting blades may be spaced apart from the upper surface of the conveyor by a first distance and at least one other of the cutting blades may be spaced apart from the upper surface of the conveyor by a second distance different from the first distance.

In some embodiments, the array of cutting blades may include central cutting blades positioned between peripheral cutting blades, and in the extended position, each of the central cutting blades may be spaced apart from the upper surface of the conveyor by a first distance, and each of the peripheral cutting blades may be spaced apart from the upper surface of the conveyor by a second distance greater than the first distance.

In some embodiments, the conveyor may include a plurality of spikes extending upwardly from the upper surface for impaling the food item.

In some embodiments, the cutting blades in the array may be evenly spaced apart.

In some embodiments, the reciprocating movement may be a reciprocating horizontal movement.

In another aspect, a method of cutting hasselback food items is provided. The method may comprise conveying a plurality of food items on an upper surface along a path, each food item having a height perpendicular to the upper surface and a width parallel to the upper surface; and moving a cutting device, having four or more parallel cutting blades positioned side-by-side and above a food item, from a retracted position in which the cutting blades are spaced apart from the food item to an extended position. In the extended position, each of the cutting blades may penetrate 50-90% of the height of the food item and cuts the entire width of the food item.

In some embodiments, in the extended position, each of the cutting blades may be spaced apart from the upper surface by a different distance.

In some embodiments, the cutting blades may include central cutting blades positioned between peripheral cutting blades, and in the extended position, each of the central cutting blades may be spaced apart from the upper surface of the conveyor by a first distance, and each of the peripheral cutting blades may be spaced apart from the upper surface of the conveyor by a second distance greater than the first distance.

In some embodiments, the method may further comprise impaling the plurality of food items on a plurality of spikes extending from the upper surface for retaining the plurality of food items on the upper surface.

In some embodiments, each of the cutting blades is wavy.

In some embodiments, in the extended position, a plurality of spaced apart portions of the food item may be positioned between different adjacent pairs of the cutting blades, and the method may further comprise removing the plurality of spaced apart portions from the food item.

### DRAWINGS

FIG. 1A is a top plan view of a hasselback potato, in accordance with at least one embodiment;

FIG. 1B is a front elevation view of the potato of FIG. 1A;

FIG. 2 is a perspective view of a system for cutting the potato of FIG. 1A, in accordance with at least one embodiment;

FIG. 3A is a top plan view of a hasselback potato, in accordance with another embodiment;

FIG. 3B is a front elevation view of the potato of FIG. 3A;

FIG. 4A is a perspective view of a system for cutting a hasselback potato, in accordance with another embodiment;

FIG. 4B is a side elevation view of the system of FIG. 4A in an extended position;

FIG. 4C is a side elevation view of the system of FIG. 4A in a retracted position;

FIG. 4D is a lower perspective view of a cutting device of the system of FIG. 4C, with portions of potato ejected from a cutting die;

FIG. 5A is a top plan view of a hasselback potato, in accordance with another embodiment;

FIG. 5B is a front elevation view of the potato of FIG. 5A;

FIG. 6 is a perspective view of a system for cutting a hasselback potato, in accordance with another embodiment;

FIG. 7A is a perspective view of a system for cutting a hasselback potato, in accordance with another embodiment;

FIG. 7B is an enlarged view of region B in FIG. 7A; and

FIG. 7C is a side elevation view of the system of FIG. 7A.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As referred to herein, a “hasselback” food item is a food item where a plurality of substantially parallel, spaced apart cuts (preferably 4 or more) have been formed in an upper portion of the food item. The width of each cut preferably extends the full width of the food item where the cut is made, and the depth of each cut is preferably less than the height of the food item (and preferably greater than half the height of the food item) where the cut is made. Accordingly, none of the cuts intersect, and none of the cuts divide the food item into discrete pieces. The resulting food item includes an upper portion having a plurality of upstanding spaced apart strips which extend from an uncut lower portion.

In one aspect, a hasselback food item may provide a unique combination of textures and enhanced surface area for flavor penetration. For example, a baked and buttered hasselback potato may provide a lower portion that is soft like a baked potato, an upper portion with crispy strips like potato chips, and a rich butter flavor from melted butter flowing into the potato between the strips.

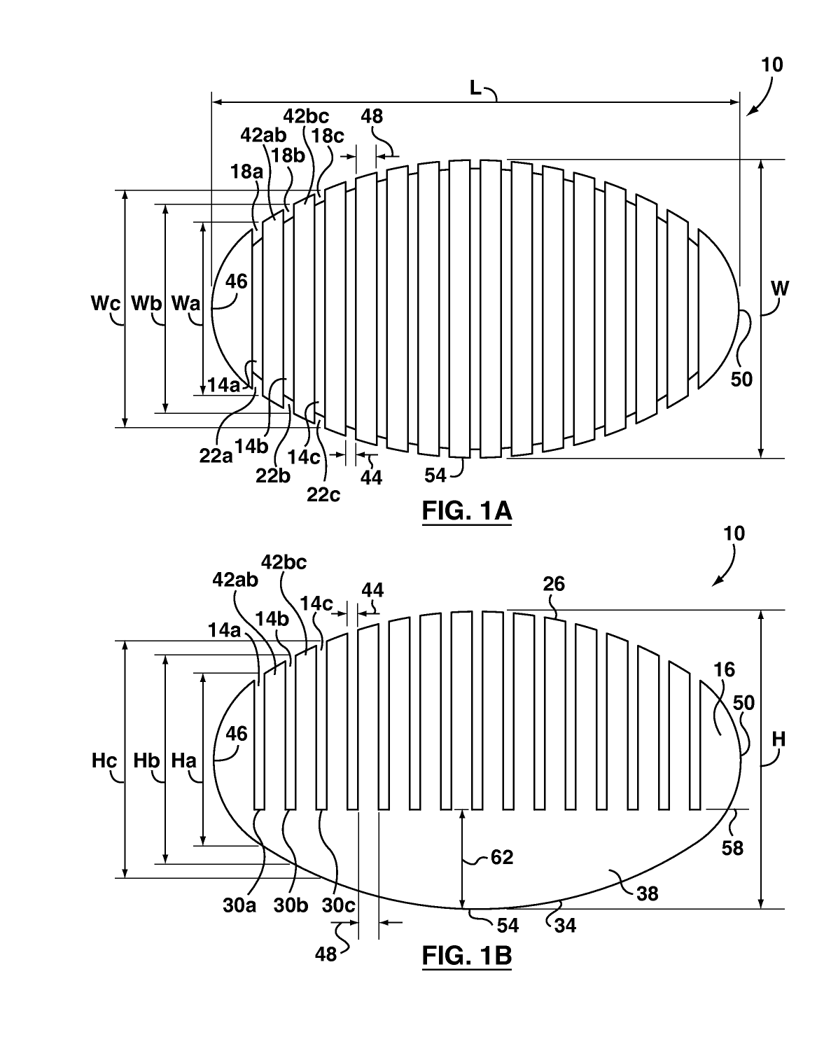

FIGS. 1A-1B show a hasselback potato 10, in accordance with at least one embodiment. Those skilled in the art will appreciate that hasselback potato 10 may be any suitable solid edible food product, such as a vegetable, a fruit, a meat product, or a dairy product. In the example shown, the potato 10 includes fifteen straight parallel spaced-apart cuts 14 formed in an upper portion 16 of the potato 10. Only a subset of cuts 14 have been labeled so as not to obscure the figures. The part number of each cut 14 includes a unique suffix (i.e. 14a, 14b, 14c, etc.) to distinguish the cut 14 from each other cut 14. Further, elements associated with a particular cut 14 are labeled with a part number having the same suffix as that cut 14 to clarify the association between the cut 14 and those elements.

Each cut 14 extends from a first cut end 18 to a second cut end 22 across a full width W of the potato 10 where the respective cut 14 is made in the upper portion 16. Further, each cut 14 extends in depth from an upper surface 26 of the potato 10, through less than a full height H of the potato 10 where the respective cut 14 is made, to a cut lower end 30 that is spaced apart from a lower surface 34 of the potato 10. As shown, height H of the potato 10 is measured between the upper and lower surfaces 26 and 34 of potato 10 where the cut 14 is made. On average, cuts 14 preferably extend through 50%-90% and more preferably 60%-80% of the height H of potato 10 where cuts 14 are made.

Referring to FIG. 1B, potato 10 includes an uncut lower portion 38 bordered by lower surface 34 and cut lower ends 30. Cuts 14 divide upper portion 16 into a plurality of strips 42, each of which extends from uncut lower portion 38. Each strip 42 is spaced apart from each other strip 42 on both sides by a cut 14. Accordingly, the width 48 of each strip 42 is defined by the spacing between the adjacent cuts 14 that surround and form the opposite faces of the strip 42. For example, the width 48 of strip 42ab is defined by the distance between cuts 14a and 14b. Strips 42 may have any suitable width 48. Preferably, width 48 of strips 42 is between 3.0 mm and 18.0 mm, and more preferably between 3.5 mm and 4.5 mm. Further, strips 42 may be spaced apart from adjacent strips 42 by any suitable distance, which corresponds to the width 44 of cuts 14. Preferably, width 44 between strips 42 is between 1.0 mm and 12.0 mm, and more preferably between 1.8 mm and 2.5 mm.

As shown, potato 10 extends longitudinally by a length L between a first longitudinal end 46 and a second longitudinal end 50. Longitudinal length L is greater than width W or height H at longitudinal midpoint 54. In other embodiments, potato 10 may have any other suitable shape. In the case of unprocessed natural food items, such as fruits and vegetables, the shape of the food item 10 may be irregular and variable from one food item of that type to the next.

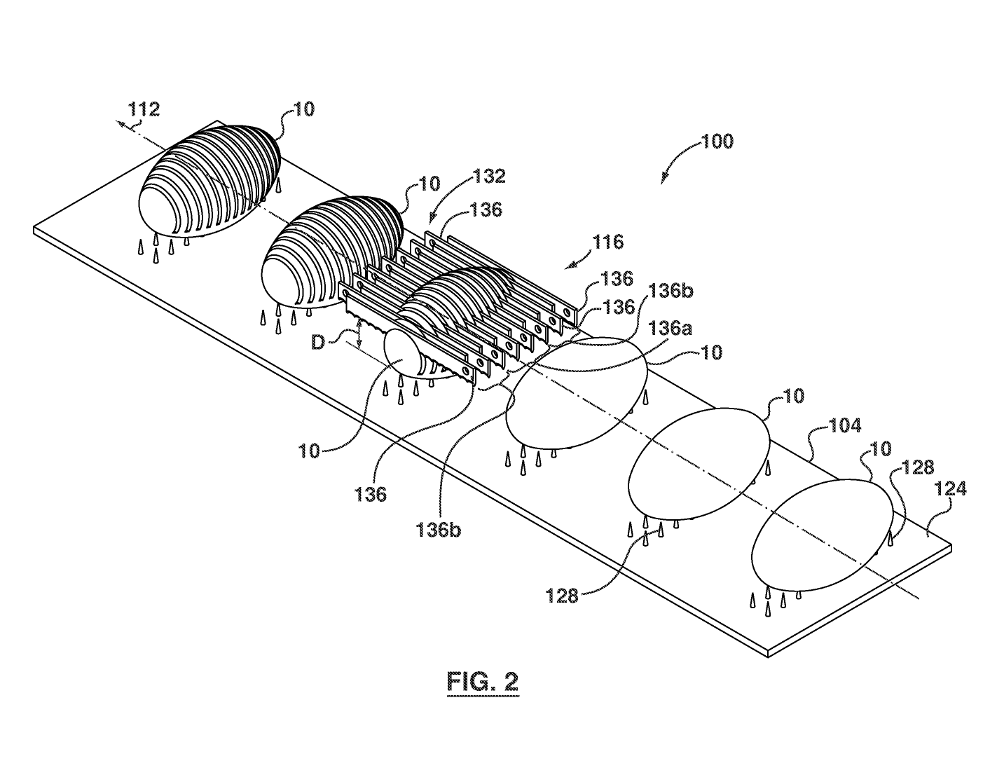

Reference is now additionally made to FIG. 2 which shows a system 100 for cutting hasselback food items, in accordance with at least one embodiment. As illustrated, system 100 may include a conveyor 104 for moving a plurality of potatoes 10 along a path 112, and a cutting device 116 with a plurality of cutting blades for cutting the potatoes 10 into hasselback cut potatoes 10.

In the example shown, conveyor 104 has an upper surface 124 for supporting the plurality of potatoes 10. Conveyor 104 may be any suitable conveyor for moving potatoes 10 along path 112, such as, for example a belt conveyor, a hydraulic conveyor, a roller conveyor, or a spiral conveyor. In the example shown, conveyor 104 includes spikes 128 which protrude upwardly from upper surface 124 for impaling lower surface 34 of potatoes 10. This may prevent potatoes 10 from moving during cutting. In other embodiments, conveyor 104 may include other suitable retentive members, such as one or more vacuum devices (not shown) positioned below upper surface 124 for drawing potatoes 10 against upper surface 124, or one or more vacuum devices (not shown) positioned to grasp the opposite longitudinal ends 46 of potatoes 10 during cutting. Alternatively, conveyor 104 may not include any other suitable retentive members.

In the illustrated example, cutting device 116 is positioned above conveyor 104 along path 112. Preferably, cutting device 116 is configured to move from a retracted position above a potato 10, downwardly through a potato 10 below to an extended position (thereby forming cuts 14 in the potato 10), and then upwardly again to the retracted position. As exemplified, cutting device 116 includes an array 132 of fifteen reciprocating blades 136. Each reciprocating blade 136 is power-driven to reciprocate, individually or as an array, while moving through an upper portion of a potato 10. Power reciprocating blades 136 of array 132 may reduce friction during cutting, form clean cuts, and maximize throughput for large-scale operations. Preferably, the cutting device 116 drives blades 136 in a horizontal reciprocating movement (e.g. parallel with upper surface 124 of conveyor 104 as shown). Alternatively, cutting device 116 may drive one or more of blades 136 in a reciprocating movement at a (non-zero) angle to horizontal.

Preferably, array 132 includes at least four blades 136. Blades 136 are preferably spaced apart and substantially parallel to one another. In operation, cutting device 116 may lower the array of blades 136 to the extended position onto a potato 10, whereby blades 136 pass through upper portion 16 of the potato 10 forming cuts 14. In the extended position, blades 136 are positioned a distance D above upper surface 124 of conveyor 104. After making the cut in the potato 10, cutting device 116 raises the array 132 of blades 136 to the retracted position above the potato 10, whereby blades 136 are withdrawn from the potato 10. The parallel cuts 14 formed in potato 10 by blades 136 defines a plurality of corresponding strips 42 which extend from an uncut lower portion 38.

In the illustrated example, blades 136 of cutting device 116 are horizontally aligned such that in the extended position each blade 136 is equally spaced the same distance D above upper surface 124 of conveyor 104. In this case, blades 136 may form cuts 14 in a potato 10 which have cut lower ends 30 which are aligned in a horizontal plane 58 as shown. Where lower surface 34 is uneven, this may form an uncut lower portion 38 having a variable height as shown. In the illustrated example, uncut lower portion 38 has a height 62 that decreases in every direction from a maximal height at longitudinal midpoint 54.

In some embodiments, blades 136 may be variably spaced apart from the upper surface 124 of conveyor 104, when in the extended position. This may permit cuts 14 of different depth to be formed in the same potato 10. For example, the depth of cuts 14 in a potato 10 may be varied in accordance with the shape of an uneven lower surface 34 of the potato 10. This may permit uncut lower portion 38 to have a more uniform height (i.e. thickness) for even cooking.

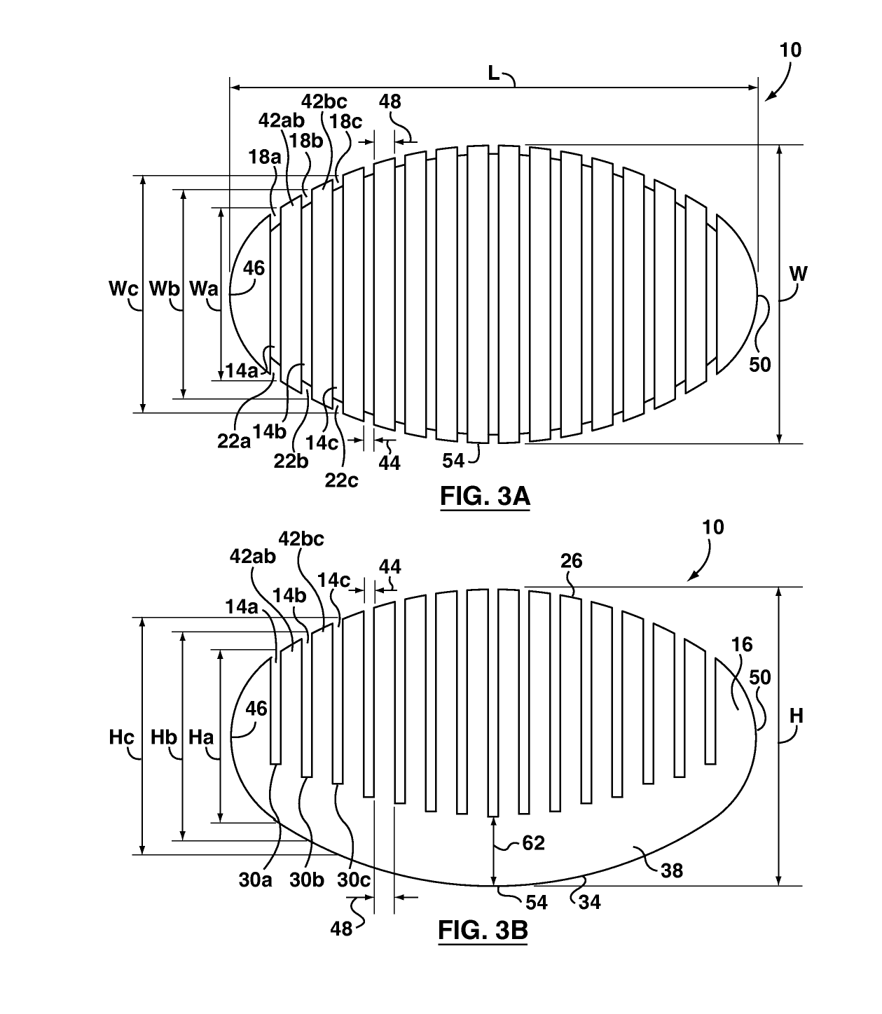

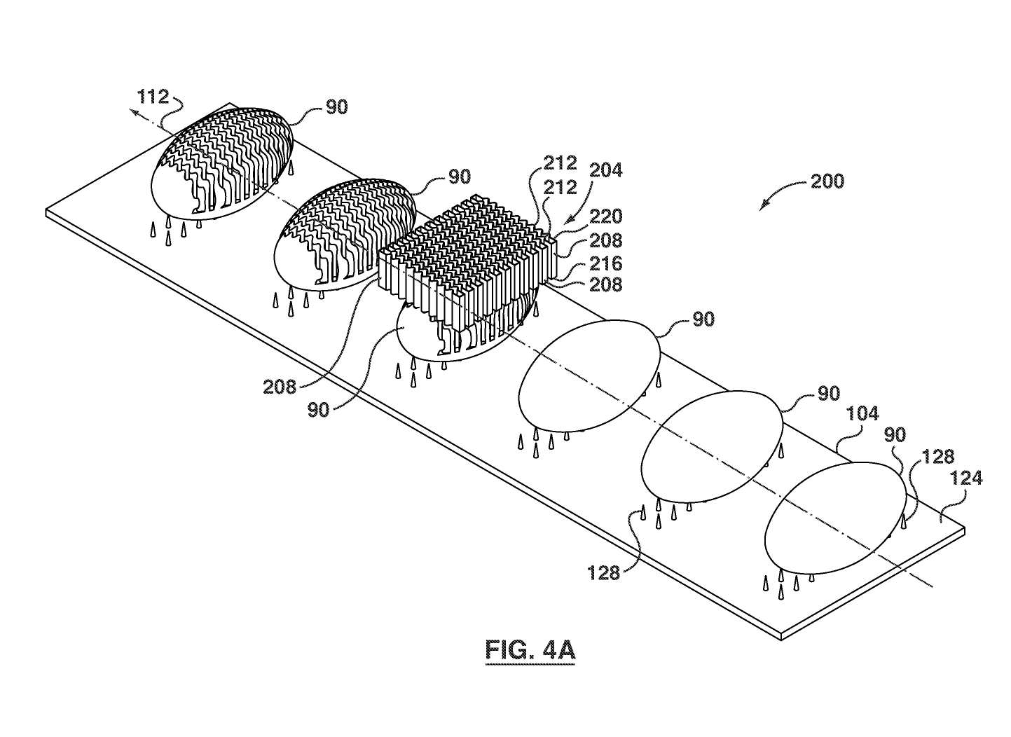

Reference is now made to FIGS. 2, and 3A-3B. FIGS. 3A-3B show a hasselback potato 70 in accordance with another embodiment. Like part numbers refer to like parts in the previous figures. Hasselback potato 70 is similar to hasselback potato 10 in many respects except, for example the depth of cuts 14.

In the illustrated example, potato 70 has an uneven (i.e. not planar) lower surface 34 that curves upwardly from longitudinal midpoint 54 toward longitudinal ends 46 and 50. The array of blades 136 may be described as having central cutting blades 136a which are positioned between peripheral blades 136b. In this case, in the extended position, central blades 136a may move closer to the upper surface 124 of conveyor 104 than peripheral blades 136b. In other words, in the extended position, the distance between central blades 136a and upper surface 124 of conveyor 104 may be greater than the distance between peripheral blades 136b and upper surface 124 of conveyor 104. For example, in the extended position, blades 136 closer to the widthwise center of the array 132 may be positioned closest to the upper surface 124 of conveyor 104. This may provide potato 10 with cuts 14 having cut lower ends 30 that are more evenly spaced apart from curved lower surface 34 to define an uncut lower portion 38 having a more consistent height across its length.

In the example shown, blades 136 of array 132 are evenly spaced apart to form evenly spaced apart cuts 14 in potato 10. In turn, strips 42 formed by cuts 14 may all have the same thickness. This may permit strips 42 to cook more evenly. Preferably, blades 136 are spaced apart from adjacent blades 136 by a distance of between 1.5 mm and 20 mm, and more preferably by a distance of between 3.5 mm and 4.5 mm.

In alternative embodiments, blades 136 of array 132 may be variably spaced apart. For example, some blades 136 of array 132 may be spaced apart from each other by a first distance, and other blades 136 of array 132 may be spaced apart from each other by a second distance. This may form cuts 14 that define strips 42 having two different thicknesses. In this case, strips 42 of the same potato 10 may provide two different textures (e.g. crispiness) when cooked. In other examples, there may be three or more different distances between adjacent blades 136. For example, no two adjacent blades 136 may be spaced apart by the same distance. This may provide an appealing home cut style.

As illustrated, blades 136 of array 132 may be arranged to span across substantially the entire length L of each of the potatoes 10 carried by conveyor 104. This may permit blades 136 to form cuts 14 which are distributed across substantially the entire longitudinal length L of the potato 10, as shown.

In alternative embodiments, blades 136 may be positioned to descend upon and cut only a portion of the length of each of the potatoes 10 carried by conveyor 104. For example, blades 136 of array 132 may be positioned to one side of path 112 in the extended position such that blades 136 form cuts 14 distributed only between longitudinal midpoint 54 and one of the longitudinal ends 46 and 50 of the potato 10. In this case, there may not be any cuts 14 formed in the potato 10 between the longitudinal midpoint 54 and the other longitudinal end 46 or 50.

In another embodiment, blades 136 may be congregated centrally with the path 112 to form cuts 14 in only a longitudinally central portion of the hasselback potato 10, leaving uncut longitudinal end portions. For example, the uncut longitudinal end portions may constitute between 10% and 50% of the potato 10 by volume, and more preferably between 15% and 25% of the potato 10 by volume.

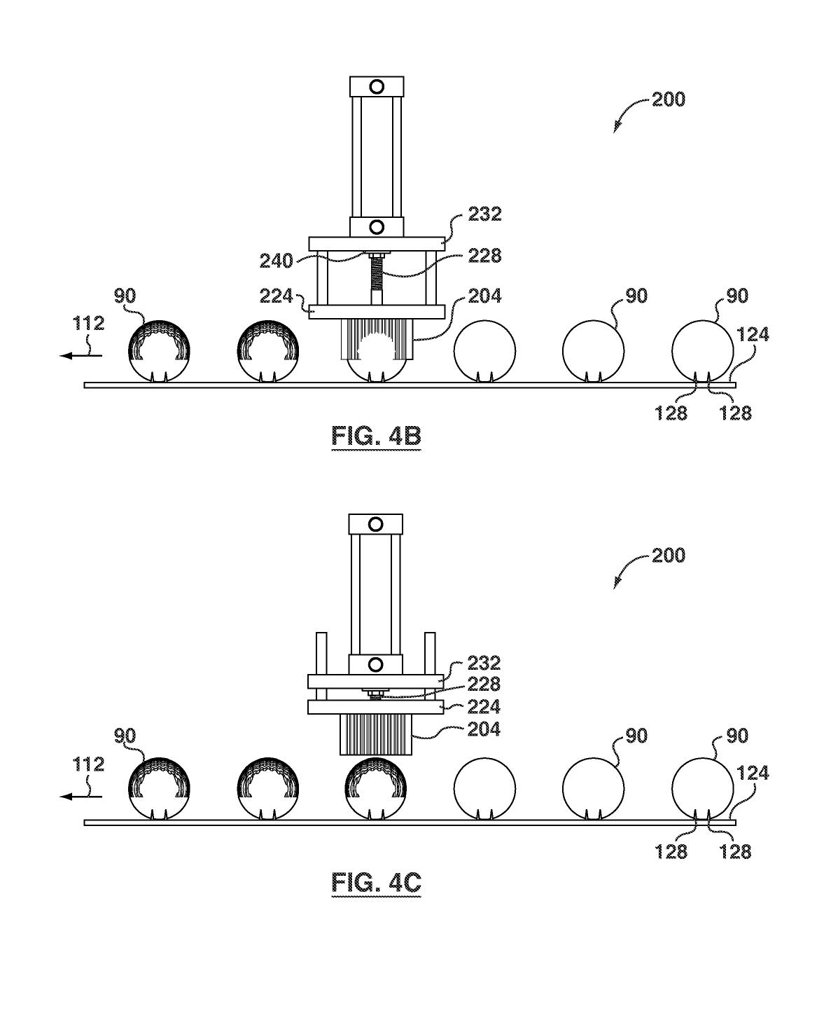

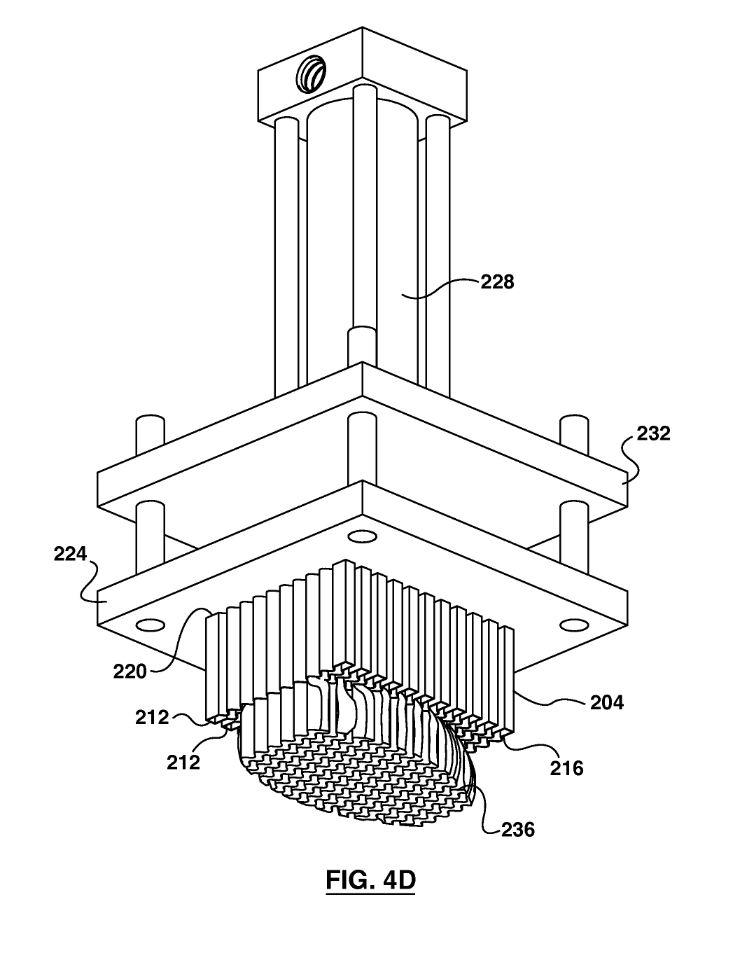

Reference is now made to FIGS. 4A-4C, where like part numbers refer to like parts in the previous figures, and where a system 200 is shown in accordance with at least one embodiment. System 200 is similar to system 100 in many aspects except, for example the cutting device.

As shown, the cutting device in system 200 includes a cutting die 204 instead of an array 132 of reciprocating blades 136. Cutting die 204 includes an array of cutting blades 208 that are similar to the reciprocating blades 136, except for example that blades 208 are fixed. As exemplified, blades 208 are substantially parallel and even spaced apart. Blades 208 move between a retracted position (FIG. 4C) and an extended position (FIG. 4B) in the same manner as described above with respect to reciprocating blades 136. As illustrated, cutting die 204 may be mounted to a support 224 which is movable toward and away from upper surface 124 by extension and retraction of a fluidic (e.g. hydraulic or pneumatic) piston cylinder 228. For example, an upper end 240 of piston cylinder 228 may be secured to a mounting fixture 232 at a fixed distance from upper surface 124, and the lower end 240 of piston cylinder 228 may be secured to support 224. In use, piston cylinder 228 may be selectively extended to move support 224 and cutting die 204 from the retracted position of FIG. 4C toward a potato 90 on upper surface 124 to the extended position of FIG. 4B. Similarly, piston cylinder 228 may be selectively retracted to move support 224 and cutting die 204 from the extended position of FIG. 4B away from the potato 90 on upper surface 124 to the retracted position of FIG. 4C.

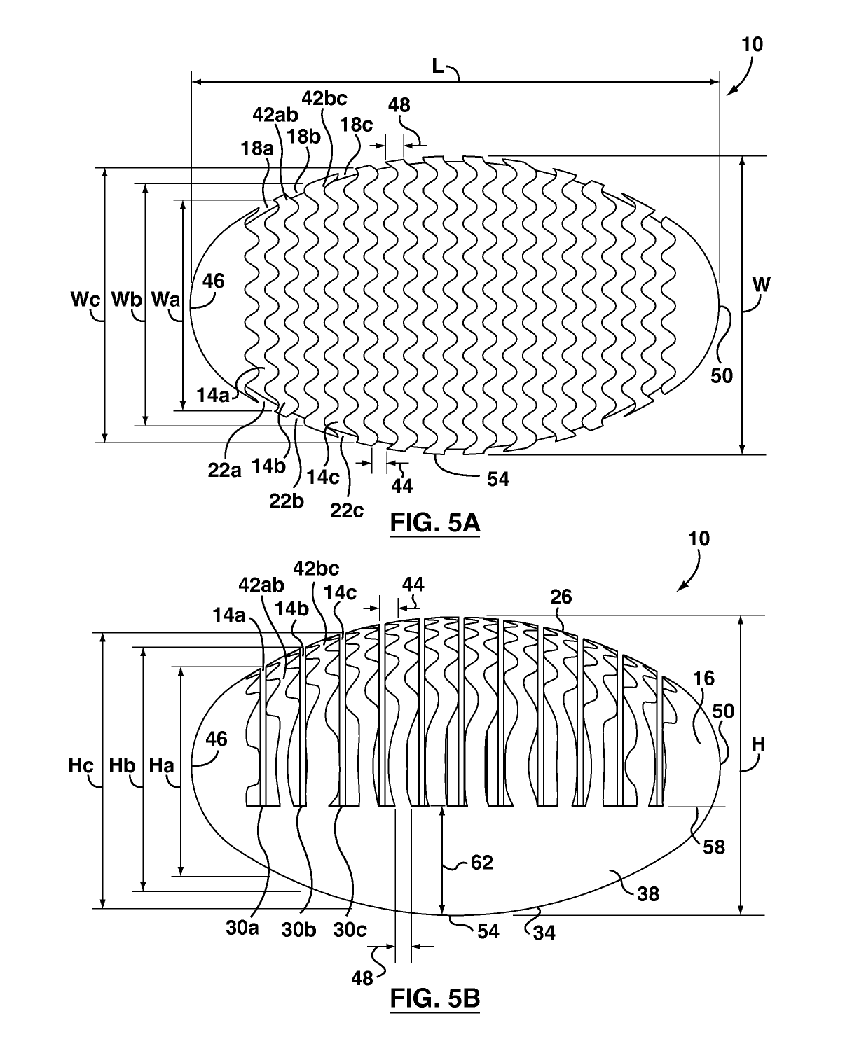

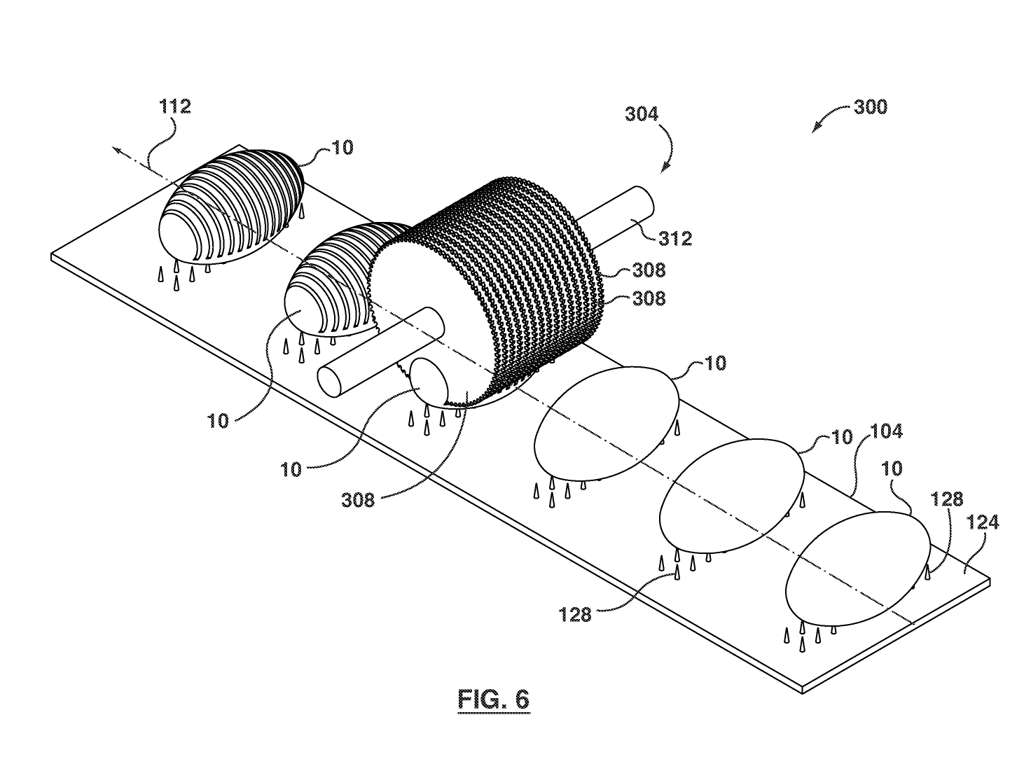

Reference is additionally made to FIGS. 5A and 5B, where like part numbers refer to like parts in the previous figures, and where a potato 90 is shown in accordance with at least one embodiment. Food item 90 is similar to potato 10 in many respects except, for example cuts 14 which are wavy instead of straight.

Blades 208 of cutting die 204 may be straight blades, like reciprocating blades 136, or formed in any suitable shape. In the illustrated example, blades 208 are wavy. In use, when blades 208 move toward the extended position, they may pass through an upper portion 16 of a potato 90 below to form wavy cuts 14.

In some embodiments, each blade 208 may include a single cutting member, or as shown, may include a pair of spaced apart cutting members 212. In the example shown, each pair of cutting members 212 of the blades 208 may capture and remove a portion of a potato 90 to form a cut 14 in a potato 90. For example, when cutting die 204 is moved into the extended position, blades 208 are moved through an upper portion 16 of a potato 90, such that the pair of cutting members 212 of each blade 208 surrounds a portion of potato 90. Afterward, cutting die 204 may be moved to the retracted position, whereby blades 208 may be withdrawn from potato 90 and whereby the portion of potato 90 between the pair of cutting members 212 of each blade 208 is removed to form a wavy cut 14 in the potato 90. As with potato 10, cuts 14 are substantially parallel and spaced apart to define strips 42 between the cuts 14.

In some examples, a pair of cutting members 212 may include high friction inside surfaces to assist with grasping and removing the portion of potato 90 positioned inside the pair of cutting members 212 when in the extended position. Alternatively, or in addition, the space between the cutting members 212 of a pair of cutting members 212 may decrease between the lower end 216 and upper end 220 of the pair of cutting members 212. This may enhance frictional contact between the pair of cutting members 212 and the portion of potato 90 between them as the cutting members 212 are moved into the potato 90. Alternatively, or in addition, a vacuum may be developed between the pair of cutting members 212 of each blade 208 to enhance the grasp of blades 208 on the portions of potato 90 captured by blades 208 during retraction. For example, gas (e.g. air) may be evacuated from the upper end 220 of cutting members 212.

Referring to FIG. 4D, after the portion 236 of potato 90 captured by cutting members 212 are removed from the potato 90 (e.g. when in the retracted position), the vacuum pressure in each cutting member 212 may be replaced by positive fluid (e.g. liquid or gas) pressure to forcefully eject the portions 236 out the lower end 216 of cutting members 212. For example, gas (e.g. air) or water may be pumped into the upper end 220 of cutting member 212.

Preferably, within each cutting blade 208, the cutting members 212 are connected. In the illustrated example, each cutting blade 208 includes an integrally formed pair of spaced apart cutting members 212. In alternative embodiments, a cutting blade 208 may include a pair of discrete cutting members 212 that are connected in any suitable manner, such as by screws, bolts, welds, or rivets.

Reference is now made to FIG. 6, where like part numbers refer to like parts and where a system 300 is shown in accordance with at least one embodiment. System 300 is similar to system 100 in many respects, except for example the cutting device.

As shown, cutting device 304 of system 300 includes a plurality of rotary blades 308 mounted to a common drive axle 312. In use, a motor (not shown) of cutting device 304 rotates drive axle 312 which drives rotary blades 308 to rotate. Instead of lowering blades 308 onto each potato 10, cutting device 304 may be continuously positioned in an extended position, whereby blades 308 form cuts 14 in an upper portion 16 of each potato 10 as conveyor 104 moves the potato 10 through the blades 308 (similar to moving wood through a table saw).

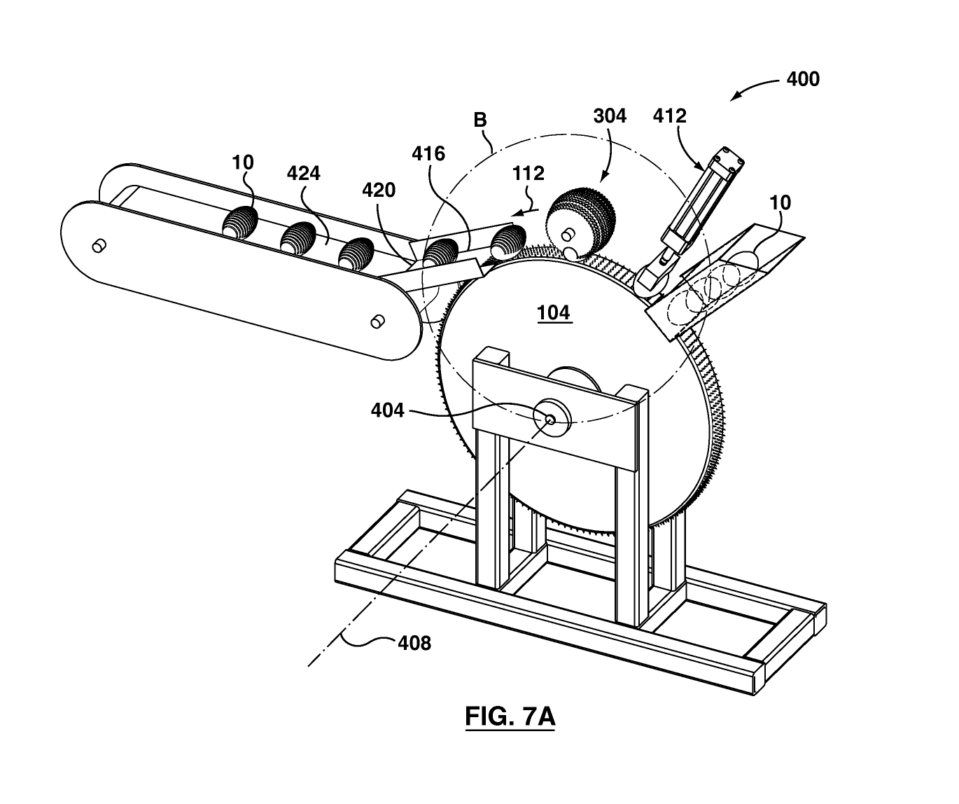

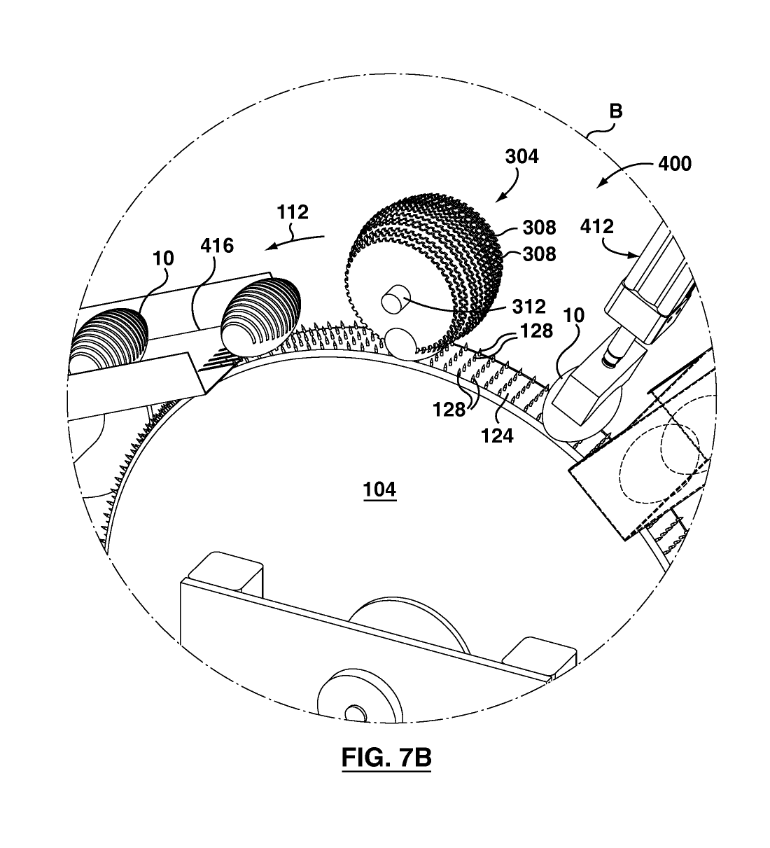

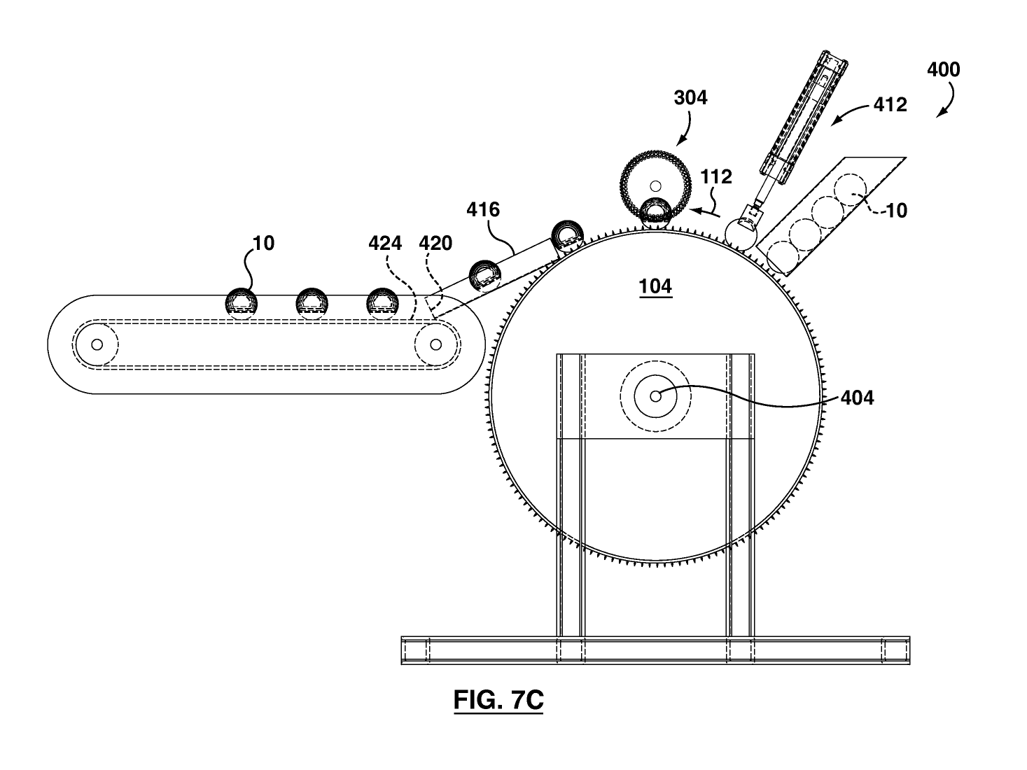

Reference is now made to FIGS. 7A-7C, where like part numbers refer to like parts in the previous figures, and where a system 400 is shown in accordance with at least one embodiment. System 400 is similar to system 300 in many respects, except for example the type of conveyor.

As illustrated, system 400 includes a rotary conveyor 104 having a continuous circular upper surface 104 extending around the periphery of the conveyor 104. Potatoes 10 may be impaled onto spikes 128 extending from upper surface 104, and transported in the rotary direction of travel 112 through cutting device 304. As exemplified, rotary conveyor 104 may be driven to rotate on an axle 404 about an axis 408 of rotation.

Potatoes 10 may be deposited on rotary conveyor 104 in any suitable manner. In the illustrated embodiment, potatoes 10 are discharged by gravity from a chute 412 onto upper surface 104 whereby the potatoes 10 are at least partially impaled onto spikes 128. As shown, conveyor 104 may transport potatoes 10 under a press 412 which may be actuated to apply pressure onto potatoes 10 toward upper surface 124. This may ensure that potatoes 10 are fully impaled onto spikes 128 before cutting potatoes 10 with cutting device 304. It will be appreciated that press 412 may be any suitable press, such as a hydraulic, pneumatic, or electric press.

After potatoes 10 are cut by device 304, they may be discharged from conveyor 124 in any suitable manner. In the illustrated embodiment, system 400 includes a ramp 416 positioned downstream of cutting device 304 for collecting potatoes 10 from conveyor 124. As shown, an outlet end 420 of ramp 416 discharges potatoes 10 onto a belt conveyor 424 for further downstream processing and/or packaging.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A system for cutting hasselback food items, the system comprising:
a conveyor having an upper surface for supporting at least one food item and for moving the food item along a path; and
a cutting die positioned above the conveyor along the path,
wherein the cutting die comprises an array of four or more parallel wavy cutting blades positioned side-by-side,
wherein the cutting die is movable between a retracted position above the food item and an extended position for moving the cutting blades through an upper portion of the food item, and
wherein in the extended position, the cutting blades are spaced apart from the upper surface of the conveyor to leave a lower portion of the food item uncut.

2. The system of claim 1, wherein:
in the extended position, at least one of the cutting blades is spaced apart from the upper surface of the conveyor by a first distance and at least one other of the cutting blades is spaced apart from the upper surface of the conveyor by a second distance different from the first distance.

3. The system of claim 2, wherein:
the array of cutting blades includes central cutting blades positioned between peripheral cutting blades, and
in the extended position, each of the central cutting blades is spaced apart from the upper surface of the conveyor by a first distance, and each of the peripheral cutting blades is spaced apart from the upper surface of the conveyor by a second distance greater than the first distance.

4. The system of claim 1, wherein:
the conveyor includes a plurality of spikes extending upwardly from the upper surface for impaling the food item.

5. The system of claim 1, wherein:
the cutting blades in the array are evenly spaced apart.

6. A system for cutting hasselback food items, the system comprising:
a conveyor having an upper surface for supporting at least one food item and for moving the food item along a path; and
a cutting device positioned above the conveyor along the path,
wherein the cutting device includes an array of four or more parallel cutting blades positioned side-by-side,
wherein the cutting device is movable between a retracted position above the food item and an extended position for moving the cutting blades through an upper portion of the food item,
wherein in the extended position,
each of the cutting blades is spaced apart from the upper surface of the conveyor to leave a lower portion of the food item uncut,
at least one of the cutting blades is spaced apart from the upper surface of the conveyor by a first distance, and
at least one other of the cutting blades is spaced apart from the upper surface of the conveyor by a second distance different from the first distance.

7. The system of claim 6, wherein:
the conveyor includes a plurality of spikes extending upwardly from the upper surface for impaling the food item.

8. The system of claim 6, wherein:
the array of cutting blades includes central cutting blades positioned between peripheral cutting blades, and
in the extended position, each of the central cutting blades is spaced apart from the upper surface of the conveyor by a first distance, and each of the peripheral cutting blades is spaced apart from the upper surface of the conveyor by a second distance greater than the first distance.

9. The system of claim 6, wherein:
the cutting blades in the array are evenly spaced apart.

10. A system for cutting hasselback food items, the system comprising:
a conveyor having an upper surface for supporting at least one food item and for moving the food item along a path; and
a powered cutting device positioned above the conveyor along the path,
wherein the cutting device is drivingly coupled to an array of four or more parallel side-by-side cutting blades, wherein the cutting device drives the cutting blades in a reciprocating movement;
wherein the array of cutting blades is movable between a retracted position above the food item and an extended position for moving the cutting blades, while reciprocating, through an upper portion of the food item ,
wherein in the extended position, the cutting blades are spaced apart from the upper surface of the conveyor to leave a lower portion of the food item uncut.

11. The system of claim 10, wherein:
in the extended position, at least one of the cutting blades is spaced apart from the upper surface of the conveyor by a first distance and at least one other of the cutting blades is spaced apart from the upper surface of the conveyor by a second distance different from the first distance.

12. The system of claim 11, wherein:
the array of cutting blades includes central cutting blades positioned between peripheral cutting blades, and
in the extended position, each of the central cutting blades is spaced apart from the upper surface of the conveyor by a first distance, and each of the peripheral cutting blades is spaced apart from the upper surface of the conveyor by a second distance greater than the first distance.

13. The system of claim 10, wherein:
the conveyor includes a plurality of spikes extending upwardly from the upper surface for impaling the food item.

14. The system of claim 10, wherein:
the cutting blades in the array are evenly spaced apart.

15. The system of claim 10, wherein
the reciprocating movement is a reciprocating horizontal movement.

16. A method of cutting hasselback food items, the method comprising:
conveying a plurality of food items on an upper surface along a path, each food item having a height perpendicular to the upper surface and a width parallel to the upper surface; and
moving a cutting device, having four or more parallel cutting blades positioned side-by-side and above a food item, from a retracted position in which the cutting blades are spaced apart from the food item to an extended position,
wherein in the extended position, each of the cutting blades penetrates 50-90% of the height of the food item and cuts the entire width of the food item.

17. The method of claim 16 wherein:
in the extended position, each of the cutting blades is spaced apart from the upper surface by a different distance.

18. The system of claim 17, wherein:
the cutting blades includes central cutting blades positioned between peripheral cutting blades, and
in the extended position, each of the central cutting blades is spaced apart from the upper surface of the conveyor by a first distance, and each of the peripheral cutting blades is spaced apart from the upper surface of the conveyor by a second distance greater than the first distance.

19. The method of claim 16 further comprising:
impaling the plurality of food items on a plurality of spikes extending from the upper surface for retaining the plurality of food items on the upper surface.

20. The method of claim 16 wherein:
each of the cutting blades is wavy.

21. The method of claim 16, wherein:
in the extended position, a plurality of spaced apart portions of the food item is positioned between different adjacent pairs of the cutting blades,
the method further comprising removing the plurality of spaced apart portions from the food item.
